(19) United States
(12) Patent Application Publication
(10) Pub. No.: US 2006/0196292 A1
(43) Pub. Date: Sep. 7, 2006

(54) Self-alignment spacer for a ball screw device

(75) Inventors: Chien-Wei Tsou, Taichung (TW); Hung-Sung Pan, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/053,042

(22) Filed: Feb. 8, 2005

(51) Int. Cl. F16H 1/24

(52) U.S. Cl. 74/424.88

(57) ABSTRACT

A self-alignment spacer for a ball screw device is disposed between respective balls of a ball screw device and comprises: at least a stuffing having a specific gravity different from that of the spacer, a center of gravity of the spacer being eccentrically positioned, so that, in operation, the spacer between the respective balls will be able to rotate in response to an acceleration force thereof.

### BACKGROUND OF THE INVENTION

1. Field of the Invention

The present invention relates to a spacer for a ball screw device, and more particularly to a self-alignment spacer for a ball screw device for prevention of friction and noise.

2. Description of the Prior Arts

Ball screw device are being widely used in different industrial fields, and specially on the large-scale precision mechanism are normally provided different types of ball screw devices, consequently, the ball screw device is always in great demand. Generally, a conventional ball screw device as shown in FIG. 1 comprises a plurality of spacers 11 disposed between the respective balls 10 for prevention of friction and noise. The spacers 11 are always required to be minimized and unitary-structured, however, such spacers are impractical due to the following reasons:

Due to enough clearance should be given between the respective balls 10 for free rolling motion of the balls 10 (the balls will not be jammed in the ball screw system), however, the clearances between the balls 10 can be accumulated to form a new space which will be large enough to cause the spacer 11 to be placed horizontally between the balls 10, and the spacer 11 horizontally positioned on the surface of a screw shaft 16 will cause the balls 10 to roll improperly. With reference to FIG. 5, the effect of the rotation of the screw shaft the spacer 11 makes it impossible for the horizontally positioned spacers 11 to stand up again, and the whole ball screw device will probably be paralysed.

Therefore, some other ball screw devices have been developed to improve the above-mentioned drawback. For example, a ball screw device disclosed by U.S. Pat. No. 6,565,947, as shown in FIG. 2, wherein the spacer 11 is provided with two grooves 12, 13, however, the clearances between the balls 10 also can be accumulated to form a space large enough to cause the spacer 11 to be horizontally positioned, and probably causing paralysis of the ball screw device.

FIG. 3 shows another ball screw device of U.S. Pat. No. 6,513,978, the spacer 11 is defined with an annular groove 14, however, when the clearances between the balls 10 are accumulated, a large space will be formed, thus causing the spacer 11 to be horizontally positioned, and further probably causing a paralysis of the ball screw device.

FIG. 4 shows another ball screw device of U.S. Pat. No. 6,347,558, a section of each of the spacers 11 is formed in the shape of a Gothic arch, forming a arch surface 15 at either side of the spacer 11, the spacer 11 is still rollable when it is tilted to a certain angle, however, when the spacer 11 completely lie down, the ball screw device will probably be paralyzed.

The present invention has arisen to mitigate and/or obviate the afore-described disadvantages.

### SUMMARY OF THE INVENTION

The primary objective of the present invention is to provide a self-alignment spacer for a ball screw device being able to rotate in response to an acceleration force during operation. The spacer has two different specific gravities which are used to make the center of gravity of the spacer be eccentrically positioned, so as to produce a tumbler effect to make the spacer between the respective balls rotate in response to gravity and centrifugal force, thus preventing the spacer from being tip over. The above-mentioned gravity and centrifugal force are called acceleration force, gravity is a gravity acceleration force caused by an attraction force between the spacer and the earth, and the centrifugal force is an inertia caused by the rotation of the spacer. Both the gravity and the centrifugal force are non-contacting force which is in direct proportion to the mass of the spacer. In this case, when different portions of the spacer are different in specific gravity, the different portions of the spacer will stand a different acceleration force, so that the spacer is eccentrically positioned. Consequently, during rotation of the screw shaft, the center of gravity of the spacer will be outwardly adjusted under the effect of the centrifugal force, or the center of gravity of the spacer will be downwardly adjusted due to the gravity.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a conventional spacer for a ball screw device;

FIG. 2 shows a spacer of a ball screw device of U.S. Pat. No. 6,565,947;

FIG. 3 shows a spacer of a ball screw device of U.S. Pat. No. 6,513,978;

FIG. 4 shows a spacer of a ball screw device of U.S. Pat. No. 6,347,558;

FIG. 5 is an operational view of a conventional spacer for a ball screw device;

FIG. 6 is an operational view of a ball screw device in accordance with the present invention;

FIG. 7 is a front view of a spacer of a ball screw device in accordance with a first embodiment of the present invention;

FIG. 8 is a cross sectional view of a spacer of a ball screw device in accordance with the first embodiment of the present invention;

FIG. 9 is an operational view of a spacer of a ball screw device in accordance with the first embodiment of the present invention;

FIG. 10 is a front view of a spacer of a ball screw device in accordance with a second embodiment of the present invention;

FIG. 11 is a cross sectional view of a spacer of a ball screw device in accordance with a second embodiment of the present invention;

FIG. 12 is an operational view of a spacer of a ball screw device in accordance with the second embodiment of the present invention.

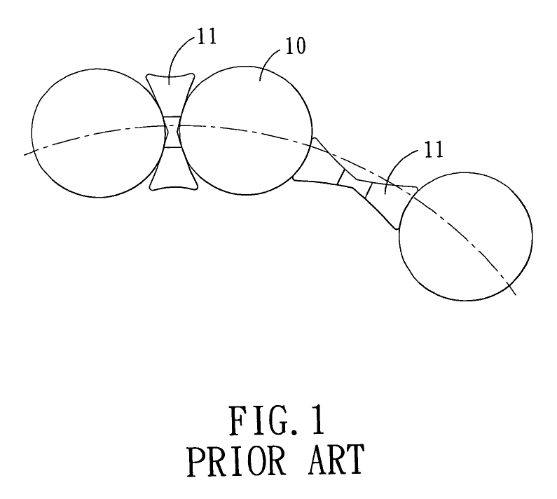

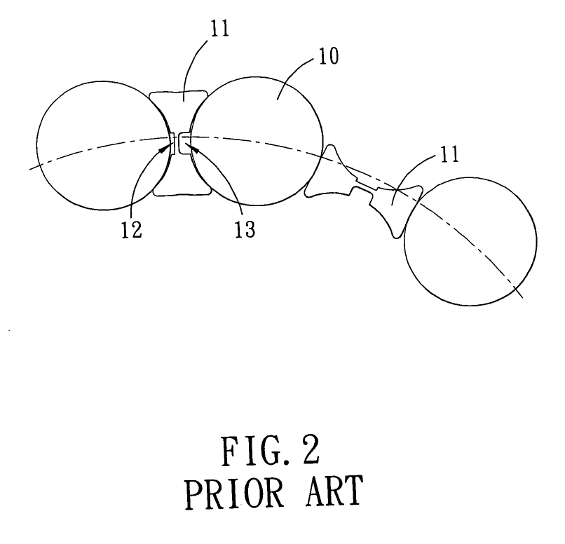

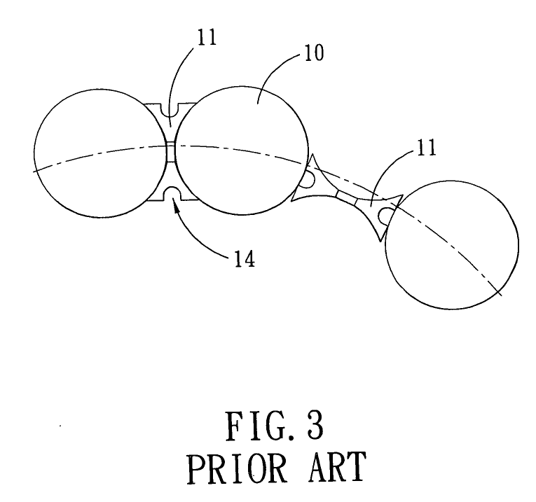

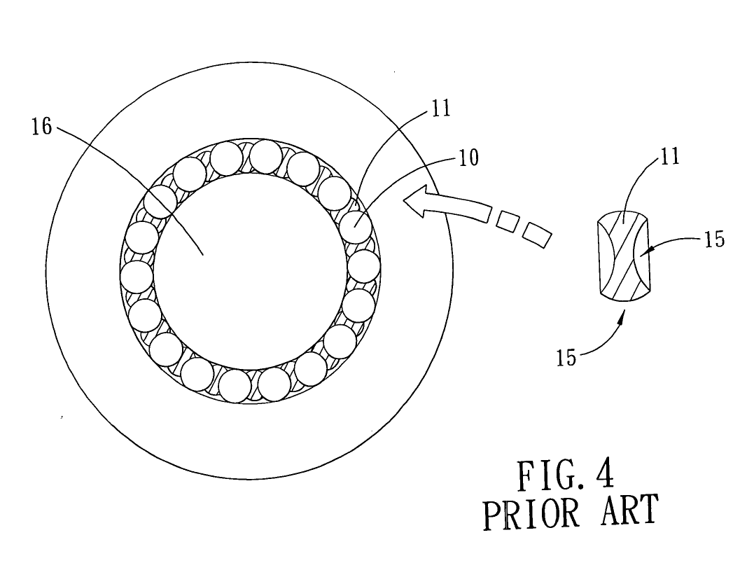

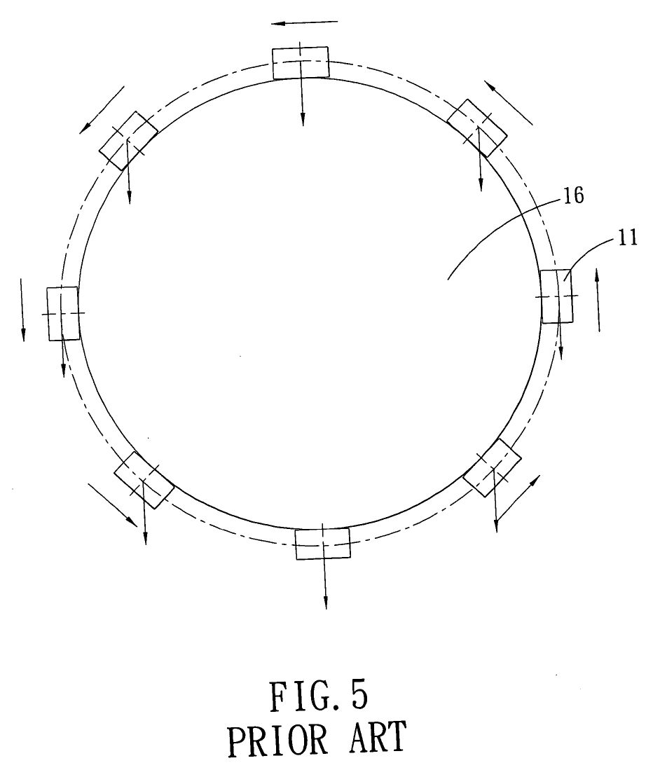

### DETAILED DESCRIPTION OF THE PREFERRED EMBODIMENTS

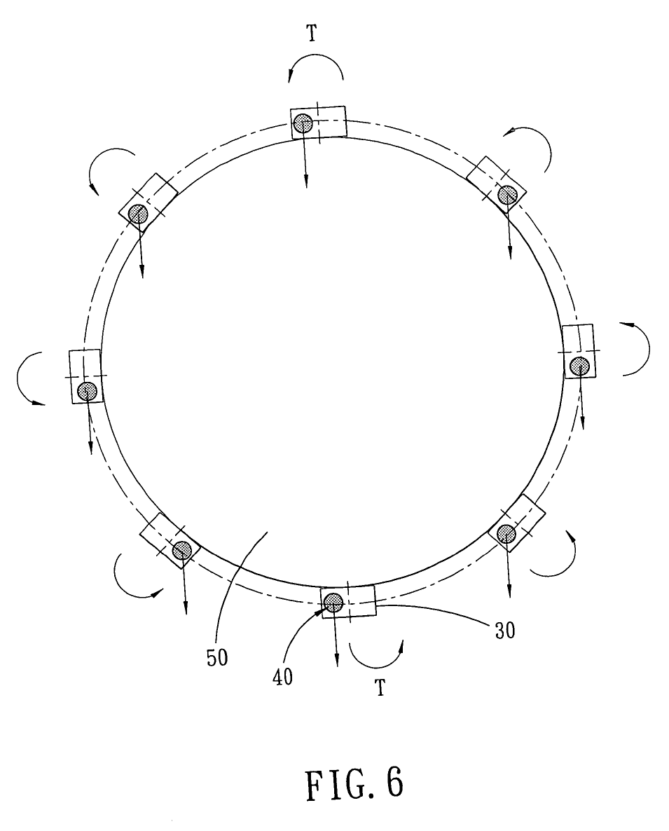

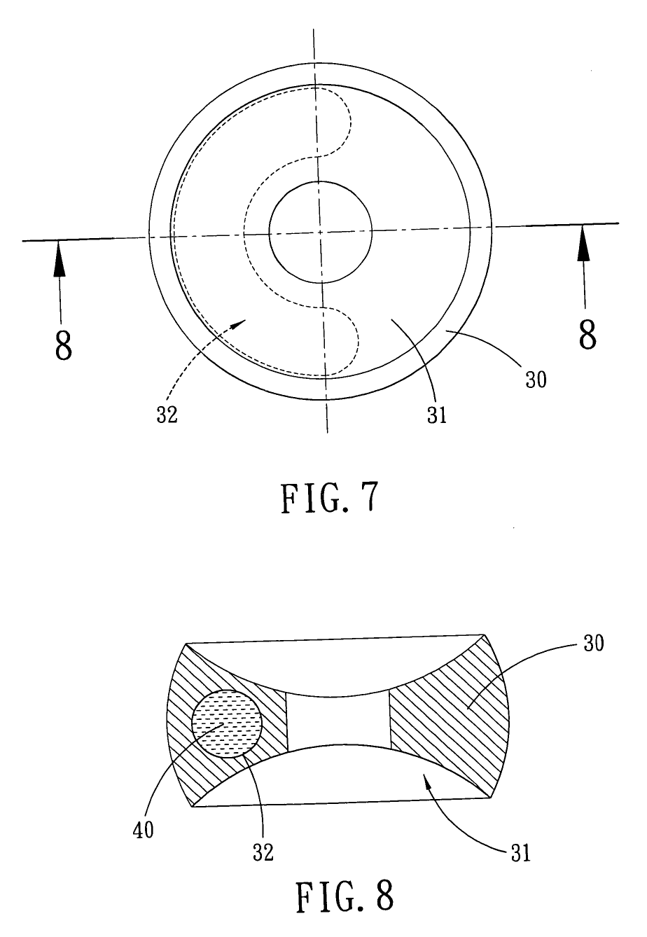

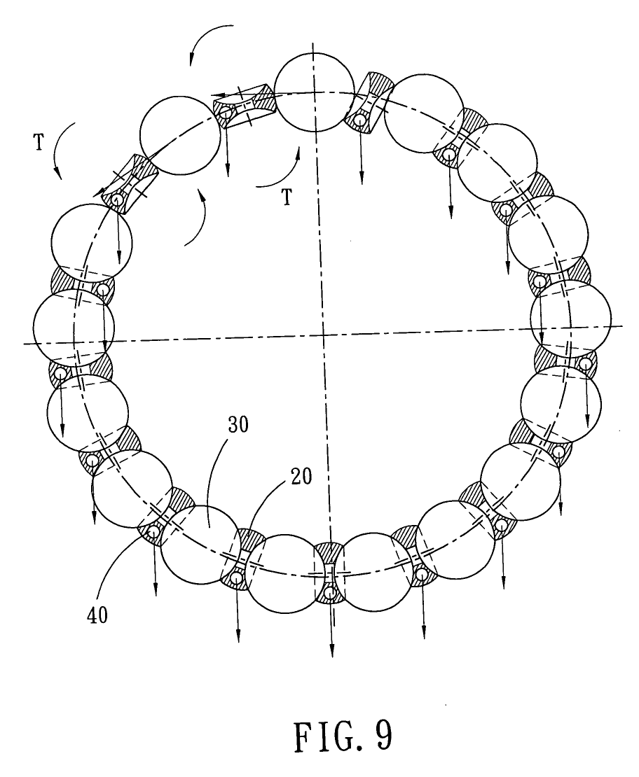

Referring to FIGS. 6-9, a plurality of self-alignment spacers 30 for a ball screw device in accordance with a first preferred embodiment of the present invention are disposed between the respective balls 20 and located on the surface of a screw shaft 50 of a ball screw.

At either side of the respective spacers 30 is formed an arc-shaped recess 31 in response to the surface of the ball 20, and in the spacer 30 is formed an arc-shaped receiving space 32 which is located off-center in the spacer 30.

A stuffing 40 having a specific gravity greater than that of the spacer 30 is stuffed in the receiving space 32, and the stuffing 40 and the spacer 30 are made of different materials, so that the center-of-gravity of the spacer 30 is eccentrically positioned.

It is to be noted that variations of the above embodiment could be utilized, as long as the spacer is made of different materials having different specific gravities are believed to fall within the scope of the invention.

For better understanding the operation and the function of the first embodiment, references should be made again to FIG. 6-9.

Since the stuffing 40 is stuffed into the receiving space 32 of the spacer 30 which is located off-center in the spacer 30, the specific gravity of the stuffing 40 is greater than that of the spacer 30, so that the center-of-gravity of the spacer 30 is eccentrically positioned. When the clearances between the respective balls 20 are accumulated at the upper and the lower sides of the screw shaft 50, the eccentric center of gravity of the spacer 11 will produce a force T (like a tumbler) to prevent the spacer 11 from tipping over. When the clearances between the respective balls 20 are accumulated at the both lateral sides of the screw bolt 50, the eccentric center of gravity of the spacer 11 will cause the spacer 11 to tumble down on the surface of the screw shaft 50, however, when the spacer 11 moves to the upper or the lower sides of the screw shaft 50, a force T will be produced to make the spacer 11 stand up again. Therefore, the spacer 11 can act in a similar way as a tumbler that never falls, preventing the balls 20 from getting stuck in the ball screw device. When the spacer 11 rotates around the screw shaft 50, the center of gravity of the spacer 11 is located oppositely to the rotating direction of the spacer 11.

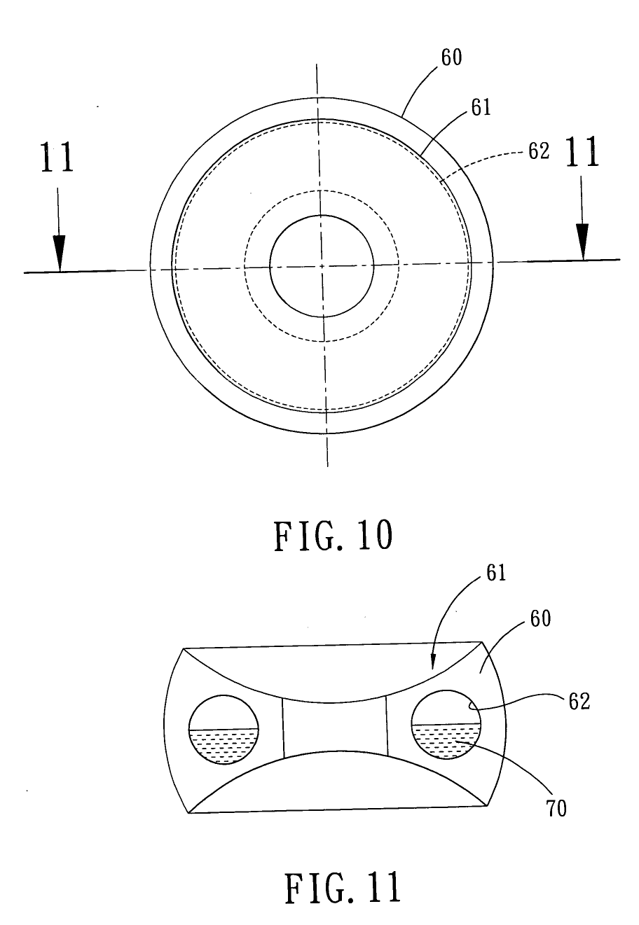

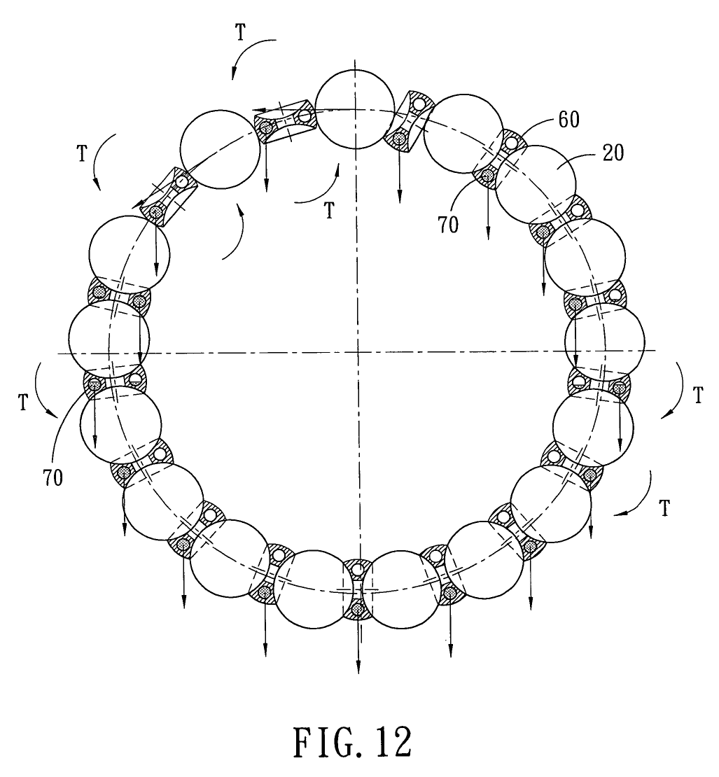

Referring to FIGS. 10-12, which show a second embodiment of the present invention, at either side of the respective spacers 60 is formed an arc-shaped recess 61 in response to the surface of the ball 20, in the spacer 60 is formed an annular passage 62 which surrounds the center of the spacer 60.

A stuffing 70 is a liquid having a specific gravity greater than that of the spacer 60 and occupies a part of the annular passage 62, so that the center-of-gravity of the spacer 60 is eccentrically positioned.

Since the stuffing 70 is a liquid and only occupies a part of the annular passage 62 of the spacer 60, it will keep flowing, during the movement of the spacer 60, to adjust the center of gravity of the spacer 60 continuously. When the clearances between the respective balls 20 are accumulated at the upper and the lower sides of the screw shaft, the liquid-like stuffing 70 will adjust the center of gravity of the spacer 60, thus producing a force T to prevent the spacer 60 from tip over. Since the stuffing 70 in this embodiment can keep flowing in the annular passage 62, plus the rotation of the screw shaft, the center of gravity of the spacer 60 will be adjusted constantly, that will make it easier for the spacer 60 of this embodiment to produce a force T as compared with that of the first embodiment. Therefore, the spacer 60 of the second embodiment also can act in a similar way as a tumbler, preventing the balls 20 from getting stuck in the ball screw device.

While we have shown and described various embodiments in accordance with the present invention, it should be clear to those skilled in the art that further embodiments may be made without departing from the scope of the present invention.

What is claimed is:

1. A self-alignment spacer for a ball screw device being disposed between respective balls of a ball screw device and comprising:
at least a stuffing having a specific gravity different from that of the spacer, a center of gravity of the spacer being eccentrically positioned, so that, in operation, the spacer between the respective balls will be able to rotate in response to an acceleration force thereof.

2. The self-alignment spacer for a ball screw device as claimed in claim 1, wherein the spacer is interiorly defined with passage which is arranged at periphery of the spacer, and the passage is partially filled with a liquid which is used to adjust the center of gravity of the spacer.

3. The self-alignment spacer for a ball screw device as claimed in claim 1, wherein the spacer is interiorly defined with receiving space which is eccentrically located in the spacer, the stuffing is stuffed in the receiving space of the spacer, and the stuffing has a specific gravity greater than that of the spacer.

4. The self-alignment spacer for a ball screw device as claimed in claims 1, 2 and 3, wherein the spacer is formed at both sides thereof with a recess in response to a surface of the ball.

5. The self-alignment spacer for a ball screw device as claimed in claim 3, wherein the receiving space inside the spacer is arc-shaped.

6. The self-alignment spacer for a ball screw device as claimed in claim 1, wherein the acceleration force is gravity.

7. The self-alignment spacer for a ball screw device as claimed in claim 1, wherein the acceleration force is centrifugal force.
